(19) United States
(12) Patent Application Publication
(10) Pub. No.: US 2012/0283900 A1
(43) Pub. Date: Nov. 8, 2012

(54) ACTUATOR TORQUE PRODUCTION DIAGNOSTIC

(75) Inventors: Todd D. Brandel, Mears, MI (US); Anthony Christman, Madison Heights, MI (US); Andrew M. Zettel, Ann Arbor, MI (US)

(73) Assignee: GM GLOBAL TECHNOLOGY OPERATIONS LLC, Detroit, MI (US)

(21) Appl. No.: 13/102,173

(22) Filed: May 6, 2011

(51) Int. Cl. G06F 19/00

(52) U.S. Cl. 701/22; 180/65.21; 903/902

(57) ABSTRACT

An example hybrid vehicle includes a control unit that generates a control signal representing an expected torque, a first actuator that generates a first torque, a second actuator that generates a second torque associated with operating characteristics of the second actuator, and a gearbox that can receive the torque generated by the first and second actuators. A controller can determine whether the first torque produced by the first actuator is substantially the same as the expected torque based on one or more operating characteristics of the second actuator. An example method includes deriving an actual torque of the first actuator based on the operating characteristics of the second actuator, defining a torque deviation from the actuator torque and the expected torque, comparing the torque deviation to a calibration threshold, and diagnosing that the first actuator has failed if the torque deviation exceeds the calibration threshold.

### TECHNICAL FIELD

The disclosure relates to a system and method of assessing torque production of an actuator in a hybrid vehicle.

### BACKGROUND

Passenger and commercial vehicles use various components to generate a propulsion torque. Gasoline powered vehicles use an internal combustion engine to propel the vehicle while electric vehicles use one or more electric motors to generate a torque from electrical energy. Hybrid vehicles use a combination of an internal combustion engine and one or more electric motors that can each generate a torque. The torque from the engine, the motor, or both, can contribute to the propulsion torque.

### SUMMARY

A hybrid vehicle includes at least one control unit configured to generate a control signal representing an expected torque. A first actuator is in communication with at least one of the control units and is configured to generate a first torque. A second actuator is in communication with at least one of the control units and is configured to generate a second torque associated with one or more operating characteristics of the second actuator. A gearbox is selectively coupled to the first actuator and the second actuator to receive at least one of the first torque and the second torque. A controller is in communication with at least one of the control units and is configured to determine whether the first torque produced by the first actuator is substantially the same as the expected torque based on one or more operating characteristics of the second actuator.

The above features and the advantages of the present disclosure are readily apparent from the following detailed description of the best modes for carrying out the invention when taken in connection with the accompanying drawings.

### BRIEF DESCRIPTION OF THE DRAWINGS

FIG. 1 is a schematic diagram of a hybrid vehicle having a controller configured to assess the torque production of an actuator.

FIG. 2 illustrates a flowchart of an example process that may be implemented by the controller of FIG. 1.

### DETAILED DESCRIPTION

An example hybrid vehicle has actuators, such as an engine and one or more motors, and a controller that can assess the torque production of one actuator based on the operating characteristics of one or more other actuators. For example, under normal operating conditions, the engine generates a torque in accordance with a control signal received from an engine control unit. The controller may compare the performance of one or more of motors to determine whether the actual torque produced by the engine is substantially the same as the amount of torque commanded by the engine control unit.

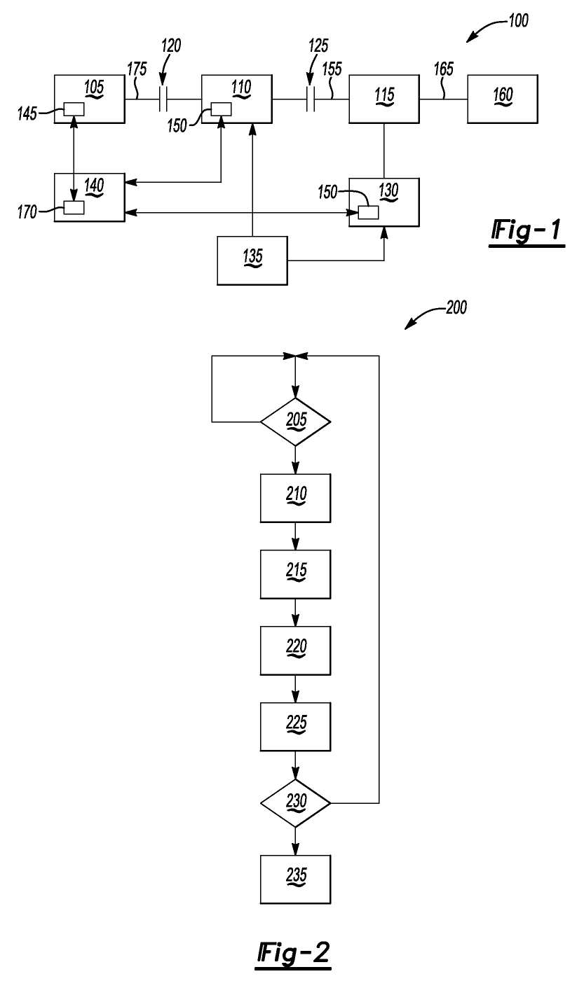

FIG. 1 illustrates an example vehicle 100 that includes an engine 105, a first motor 110, a gearbox 115, a first clutch 120, a second clutch 125, a second motor 130, and a controller 140. The vehicle 100 may take many different forms and include multiple and/or alternate components and facilities. While an example vehicle 100 is shown in FIG. 1, the components illustrated are not intended to be limiting. Indeed, additional or alternative components and/or implementations may be used. For instance, the vehicle 100 may be any passenger or commercial automobile such as a hybrid electric vehicle including a plug-in hybrid electric vehicle (PHEV) or an extended range electric vehicle (EREV), a gas-powered vehicle, a battery electric vehicle (BEV), or the like.

The engine 105 may include any device that is configured to generate an engine torque by converting fuel into rotational motion. For instance, the engine 105 may be an internal combustion engine that can combust a mixture of fuel and air using an Otto cycle, a Diesel cycle, or any other thermodynamic cycle to generate rotational motion. The engine 105 may output the engine torque via a crankshaft 175. An engine control unit 145 may be in communication with the engine 105 and command the amount of engine torque produced by the engine 105. That is, the engine control unit 145 may generate an engine control signal that commands the engine 105 to rotate at a particular speed and/or produce a particular amount of torque (e.g., the expected engine torque). The engine 105, therefore, may be configured to receive the engine control signal and generate the engine torque in accordance with the engine control signal. In some instances, such as during an engine failure discussed in greater detail below, the actual engine torque may be substantially different than the expected engine torque.

The first motor 110 may include any device configured to generate a motor torque from electrical energy. For instance, the first motor 110 may be configured to receive electrical energy from a power source 135 such as a battery, and generate the motor torque in accordance with the amount of electrical energy received. The first motor 110 may be configured to receive direct current (DC) energy or alternating current (AC) energy. In some instances, the first motor 110 may be configured to generate electrical energy that can be, for instance, stored in the power source 135. A motor control unit 150 in communication with the first motor 110 may be configured to generate a motor control signal that commands the first motor 110 to rotate at a particular speed and/or produce a particular amount of torque (e.g., the commanded motor torque). That is, the motor control signal may cause the first motor 110 to draw a sufficient amount of electrical energy from the power source 135, and in response, rotate at a particular speed and/or produce the commanded torque. The actual motor torque produced, however, may be different than the commanded motor torque, which may indicate a motor failure, as discussed in greater detail below. Like the first motor 110, the second motor 130 may include any device configured to generate a motor torque from electrical energy. The amount of torque produced may be based upon, e.g., a motor control signal generated by either the same or a different motor control unit 150 as the first motor 110.

In addition, the motor control unit 150 may be configured to output one or more performance signals representing various operating characteristics of the first motor 110, the second motor 130, or both. Some example operating characteristics include the amount of torque provided to the first and/or second motor 110, 130 from the engine 105, the amount of power generated by the first and second motors 110, 130, the output speed of the first and second motors 110, 130, the electrical energy provided to each of the motors 110, 130, etc.

The gearbox 115 may include any device configured to convert a received torque into a propulsion torque that may be used to propel the vehicle 100. As illustrated, the gearbox 115 is selectively coupled to the engine 105 and the first motor 110 to receive the engine torque, the motor torque, or a combination of both. The gearbox 115 may receive torque from the engine 105, first motor 110, and/or the second motor 130 via one or more input shafts 155 and output the propulsion torque to, e.g., wheels 160 of the vehicle 100 via an output shaft 165. Between the input shaft 155 and the output shaft 165, the gearbox 115 may include any number of gears (not shown) having various sizes and configurations that may engage to convert the received torque into the propulsion torque.

The first clutch 120 and the second clutch 125 may include any device configured to engage to selectively transfer torque. For instance, the first clutch 120 may be operably disposed between the engine 105 and the first motor 110 and the second clutch 125 may be operably disposed between the first motor 110 and the gearbox 115. When the first clutch 120 is engaged, the engine torque may be transferred to the first motor 110 so that the first motor 110 may generate electrical energy in accordance with the engine torque received. The second clutch 125 may engage to transfer the engine torque and/or the motor torque to the gearbox 115.

Other clutches (not shown) may be used within the gearbox 115 to control the engagement of the gears within the gearbox 115. The first clutch 120, the second clutch 125, or any other clutch within the gearbox 115 may engage to selectively connect the engine 105, the first motor 110, or the second motor 130 to the gearbox 115 so that the torque generated by any combination of these components may be used to propel the vehicle 100.

The controller 140 may include any device configured to assess the torque production of one actuator, such as the engine 105, the first motor 110, or the second motor 130, based on the operating characteristics of one or more other actuators used in the vehicle 100. As illustrated in FIG. 1, the controller 140 is in communication with the engine control unit 145, and the motor control units 150. To assess the torque production of the engine 105, the first motor 110, or the second motor 130, the controller 140 may be configured to compare the actual torque produced by one of these actuators to an expected torque. The controller 140 may be configured to determine that one of these actuators has failed if the expected torque and the actual torque are substantially different.

To compare the actual torque to the expected torque, the controller 140 may define a torque deviation from a difference between the expected torque and the actual torque. The controller 140 may compare the torque deviation to a calibration threshold representing the maximum acceptable difference between the expected torque and the actual torque. If the torque deviation exceeds the calibration threshold, the controller 140 may determine that the actuator has failed.

The calibration threshold may, in one possible approach, be defined as a single value, multiple values, or as a range of values. For instance, the controller 140 may select one or more values or a range of values based on, e.g., the different operating conditions of the vehicle 100. The controller 140, therefore, may be configured to diagnose that the actuator has failed if the torque deviation exceeds one or more of the calibration values or is outside the range of calibration values. The values associated with the calibration threshold may be stored in a memory device 170 that is part of or in communication with the controller 140. The calibration threshold may be stored in a look-up table, database, data repository, or any other data store.

The magnitude of the calibration threshold may be based on the expected torque production (e.g., the expected actual torque) of the actuator in question given the amount of torque commanded by the control unit, such as the engine control unit 145 or one of the motor control units 150. In some instances, the calibration threshold may be expressed as a percentage of the expected torque. That is, the calibration threshold may allow for the actual torque to deviate from the expected torque by a margin of 1%, 5%, 10%, etc. As the margin (e.g., percentage) increases, the controller 140 will allow a greater difference between the expected torque and the actual torque before diagnosing the failure of the actuator. Alternatively, the calibration threshold may be expressed as a magnitude having units of foot-pounds or any other unit representing a rotational force.

In the example vehicle 100 of FIG. 1, the actuator in question may be the engine 105, the first motor 110, or the second motor 130. To assess the torque production of the engine 105, the controller 140 may receive the expected engine torque from the control signal generated by the engine control unit 145. The controller 140 may determine the actual engine torque from the operating characteristics of the first motor 110, the second motor 130, or both. For instance, the controller 140 may receive the performance signals generated by one or both motor control units 150. As discussed above, the performance signals represent operating conditions, such as the amount of torque provided to the first and/or second motor 110, 115 from the engine 105, the amount of power generated by the first and second motors 110, 130, the output speed of the first and second motors 110, 130, the electrical energy provided to each of the motors 110, 130, etc. The controller 140 may use the performance signals to determine, for instance, the amount of torque produce by the first motor 110, the second motor 130, or both, along with the propulsion torque and the configuration of the gearbox 115 to determine the actual amount of torque produced by the engine 105.

The controller 140 may further compare the actual engine torque to the expected engine torque and diagnose an engine failure if the actual engine torque is substantially different than the expected engine torque. That is, the controller 140 may define an engine torque variation based on, e.g., a difference between the actual engine torque and the expected engine torque and compare the engine torque variation to an engine calibration threshold. The controller 140 may diagnose the engine failure if, for instance, the engine torque variation exceeds the engine calibration threshold.

The controller 140 may be configured to take a similar approach to assess the torque production of the first motor 110 or the second motor 130. For example, the controller 140 may derive the expected motor torque from the motor control signal generated by one of the motor control units 150 and derive the actual motor torque from the performance signals representing either the operating characteristics of the engine 105 and/or the second motor 130. The controller 140 may compare the actual motor torque to the expected motor torque and diagnose the motor failure if, e.g., the actual motor torque is substantially different than the expected motor torque. In one possible implementation, the controller 140 may define a motor torque variation as the difference between the actual and expected motor torques. The controller 140 may be configured to diagnose the motor failure if the motor torque variation exceeds a motor calibration threshold.

The controller 140 may be further configured to recognize that, under certain circumstances, the actual torque may be substantially different than the expected torque even though the actuator in question is operating properly. For instance, the actual torque may differ from the expected torque when the vehicle 100 loses traction. Additionally, the difference between the actual torque and the expected torque may be caused by a mechanical delay (e.g., the time for the engine 105, first motor 110, or second motor 130 to respond to the control signal), and therefore, the actual torque produced may not immediately reflect the expected torque. Accordingly, the controller 140 may be configured to allow the torque variation to exceed the calibration threshold a predetermined number of times during a predetermined time period before diagnosing that the actuator has failed. As such, the controller 140 may only diagnose the actuator failure if the torque deviation is consistently different than the calibration threshold, and thus, avoid identifying a failure due to occasional or transient differences between the actual torque and the expected torque.

Similarly, the controller 140 may be configured to assess the torque production of the actuator when the actual torque should be substantially the same as the expected torque. Thus, before diagnosing a actuator failure, the controller 140 may be configured to execute an enable diagnostic procedure to identify whether the actual torque and the expected torque should be substantially the same. During the enable diagnostic procedure, the controller 140 may be configured to consider the configuration of the gears in the gearbox 115 as well as any clutches used in the vehicle 100. The controller may use the engagement of the clutches and the configuration of the gears to determine which of the actuators is generating the torque that contributes to the propulsion torque. With this information, the controller 140 may determine the actual torque of one of the actuators, and thus, determine whether the actuator in question has failed. The controller 140 may be further configured to consider whether the control signals generated by the engine control unit 145, the motor control units 150, or both, are stable during the enable procedure. Unstable control signals may cause the controller 140 to falsely represent the expected torque, which may lead to false prime failure diagnoses. Moreover, the controller 140 may be configured to identify a communication error between the one of the control units 145, 150 and the controller 140 since this and possibly other communication errors may affect the ability of the controller 140 to receive the performance signal and properly identify the actual torque based on the operating characteristics of other actuators in the vehicle 100.

In general, computing systems and/or devices, such as the controller 140, the engine control unit 145, the motor control unit 150, etc., may employ any of a number of computer operating systems and may include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Look-up tables, databases, data repositories, or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device employing a computer operating system such as one of those mentioned above, and may be accessed via a network in any one or more of a variety of manners. A file system may be accessible from a computer operating system, and may include files stored in various formats. An RDBMS may employ the Structured Query Language (SQL) in addition to a language for creating, storing, editing, and executing stored procedures, such as the PL/SQL language mentioned above.

FIG. 2 illustrates an example process 200 that may be implemented by the controller 140 to, e.g., assess the torque production of one of the actuators, such as the engine 105, the first motor 110, or the second motor 130, of the vehicle 100 of FIG. 1.

At decision block 205, the controller 140 may execute the enable diagnostic procedure to, e.g., determine whether the actual torque and the expected torque should be substantially the same given various circumstances. During the enable diagnostic procedure, the controller 140 may consider whether the control signals generated by the control unit are stable. As discussed above, unstable control signals may cause the controller 140 to falsely diagnose the actuator failure. Moreover, the controller 140 may identify communication errors between the control unit and the controller 140, since this and possibly other communication errors may affect the ability of the controller 140 to identify actuator failures. If the control signal is stable and there are no communication errors that may affect the assessment of the torque production of the actuator, the process 200 may continue at block 210. Otherwise, the process 200 may repeat block 205 until the assessment is likely to yield more reliable results.

Moreover, as part of the enable diagnostic procedure at block 205, the controller 140 may identify which actuators are currently contributing to the propulsion torque that propels the vehicle 100. For instance, the controller 140 may determine which of the clutches 120, 125, and other clutches (not shown) in the gearbox 115, are engaged as well as the configuration of the gears within the gearbox 115 to determine which actuators are presently contributing to the propulsion torque. If the controller 140 determines that a sufficient number of actuators are providing the propulsion torque, the process 200 may continue at block 210. Otherwise, the process 200 may repeat block 205 until enough actuators are contributing to the propulsion torque that the controller 140 is able to more accurately determine the actual torque of the actuator in question.

At block 210, the controller 140 may receive the control signal generated by the control unit, which may be the engine control unit 145 or one of the motor control units 150. As discussed above, the control signal may control the operation of the actuator in question by, for example, commanding the actuator to generate a particular torque (e.g., the expected torque). Therefore, in addition to transmitting the control signal to the engine 105, the first motor 110, or the second motor 130, the control unit may further transmit the control signal to the controller 140.

At block 215, the controller 140 may receive the performance signal generated by one of the control units, such as the control unit associated with the other actuators in the vehicle that contribute to the propulsion torque besides the actuator in question. That is, if the engine 105, the first motor 110, and the second motor 130 each presently contribute to the propulsion torque, and if the engine 105 is the actuator in question, the controller 140 may receive performance signals from the motor control units 150 that represent operating characteristics of the first motor 110 and the second motor 130.

At block 220, the controller 140 may derive the actual torque of the actuator in question from the operating characteristics of one or more of the other actuators in the vehicle. Continuing with the example above where the engine 105 is the actuator in question, at block 220, the controller 140 may use the operating characteristics of the first motor 110, the second motor 130, or both, as well as, e.g., the configuration of the gearbox 115 and the propulsion torque provided to the wheels 160 of the vehicle 100 to determine the actual torque provided by the engine 105. As discussed above, the operating characteristics considered by the controller 140 may include the amount of torque provided to the first and/or second motor 110, 130 from the engine 105, the amount of power generated by the first and second motors 110, 130, the output speed of the first and second motors 110, 130, the electrical energy provided to each of the motors 110, 130, etc.

At block 225, the controller 140 may compare the actual torque to the expected torque to define the torque deviation. The torque deviation, in one possible implementation, may represent the difference between the expected torque and the actual torque.

At decision block 230, the controller 140 may determine whether the torque deviation exceeds the calibration threshold. The calibration threshold may represent the maximum allowable difference between the expected torque and the actual torque when the actuator in question is operating properly. In one possible approach, the calibration threshold may be defined by one or more values, including a range of calibration values. If the torque deviation is less than the calibration threshold or within the range of calibration values, the controller 140 may determine that the actuator is operating properly, and the process 200 may return to decision block 205. If the torque deviation exceeds the calibration threshold or the range of calibration values, the process 200 may continue at block 235. As discussed above, the controller 140 may recognize that, under certain circumstances, the actual torque generated by the actuator may be substantially different than the expected torque even though the actuator is operating properly. Accordingly, at decision block 230, the controller 140 may wait for the torque deviation to exceed the calibration threshold a predetermined number of times within a predetermined time interval before continuing to block 235. For instance, the controller 140 may count the number of times the torque deviation exceeds the calibration threshold and only proceed to block 235 if the torque deviation exceeds the calibration threshold the predetermined number of times within the predetermined time interval.

At block 235, the controller 140 may diagnose the actuator failure and, if necessary, take a remedial action. That is, the controller 140 may set a flag indicating that the actuator has failed. When the flag is set, the failed actuator may be unavailable for use at least until the next key cycle or until the vehicle 100 is serviced. The controller 140 may also illuminate an indicator light on a dashboard (not shown) within a passenger compartment (not shown) of the vehicle 100 so that, for instance, the driver of the vehicle 100 knows that there is an issue with the actuator that requires attention.

While the best modes for carrying out the invention have been described in detail, those familiar with the art to which this invention relates will recognize various alternative designs and embodiments for practicing the invention within the scope of the appended claims.

1. A hybrid vehicle comprising:
at least one control unit configured to generate a control signal representing an expected torque;
a first actuator in communication with at least one of the control units and configured to generate a first torque;
a second actuator in communication with at least one of the control units and configured to generate a second torque associated with one or more operating characteristics of the second actuator;
a gearbox selectively coupled to the first actuator and the second actuator to receive at least one of the first torque and the second torque; and
a controller in communication with at least one of the control units and configured to determine whether the first torque produced by the first actuator is substantially the same as the expected torque based on one or more operating characteristics of the second actuator.

2. A hybrid vehicle as set forth in claim 1, wherein the controller is configured to compare the first torque to the expected torque to define a torque deviation.

3. A hybrid vehicle as set forth in claim 2, wherein the controller is configured to compare the torque deviation to a calibration threshold and determine that the first actuator has failed if the torque deviation exceeds the calibration threshold.

4. A hybrid vehicle as set forth in claim 3, wherein the calibration threshold includes a range of calibration values and wherein the controller is configured to diagnose that the first actuator has failed if the torque deviation is outside the range of calibration values.

5. A hybrid vehicle as set forth in claim 1, wherein the controller is configured to diagnose that the first actuator has failed if the first torque is substantially different than the expected torque a predetermined number of times within a predetermined time interval.

6. A hybrid vehicle as set forth in claim 1, wherein the controller is configured to determine whether the control signal generated by the control unit in communication with the first actuator is stable before diagnosing that the first actuator has failed.

7. A hybrid vehicle as set forth in claim 1, wherein the controller is configured to identify a communication error between one or more of the control units and the controller before diagnosing that the first actuator has failed.

8. A hybrid vehicle as set forth in claim 1, wherein the first actuator includes an engine configured to generate an engine torque, and wherein the first torque at least partially includes the engine torque.

9. A hybrid vehicle as set forth in claim 1, wherein the second actuator includes a motor configured to generate a motor torque, and wherein the second torque at least partially includes the motor torque.

10. A hybrid vehicle as set forth in claim 1, further comprising:
a third actuator configured to generate a third torque associated with one or more operating characteristics of the third actuator;
wherein the gearbox is selectively coupled to the third actuator to receive the third torque; and
wherein the controller is in communication with the third actuator and configured to determine whether the first torque produced by the first actuator is substantially the same as the expected torque based on at least one operating characteristic of the second actuator and the third actuator.

11. A method of assessing a torque production of a first actuator in a hybrid vehicle, the method comprising:
receiving a control signal representing an expected torque;
receiving a performance signal representing operating characteristics of a second actuator in the hybrid vehicle;
deriving, via a computing device, an actual torque of the first actuator based on at least one operating characteristic of the second actuator;
comparing the actual torque to the expected torque to define a torque deviation;
comparing the torque deviation to a calibration threshold; and
diagnosing, via the computing device, that the first actuator has failed if the torque deviation exceeds the calibration threshold.

12. A method as set forth in claim 11, wherein the calibration threshold includes a range of calibration values and wherein diagnosing that the first actuator has failed includes diagnosing that the first actuator has failed if the torque deviation is outside the range of calibration values.

13. A method as set forth in claim 11, wherein diagnosing that the first actuator has failed includes:
counting a number of times the torque deviation exceeds the calibration threshold; and
wherein diagnosing that the first actuator has failed includes diagnosing that the first actuator has failed if the torque deviation exceeds the calibration threshold a predetermined number of times within a predetermined time interval.

14. A method as set forth in claim 11, further comprising executing an enable diagnostic procedure before diagnosing that the first actuator has failed.

15. A method as set forth in claim 14, wherein executing the enable diagnostic procedure includes determining whether the control signal is stable.

16. A method as set forth in claim 14, wherein the control signal is generated by a control unit and wherein executing the enable diagnostic procedure includes identifying a communication error between the control unit and the computing device.

17. A method as set forth in claim 11, wherein receiving the performance signal includes:
receiving a first performance signal representing operating characteristics of a second actuator in the hybrid vehicle; and
receiving a second performance signal representing operating characteristics of a third actuator in the hybrid vehicle.

18. A method as set forth in claim 17, wherein deriving the actual torque of the first actuator includes deriving the actuator torque of the first actuator based on at least one operating characteristic of the second actuator and the third actuator.

19. A hybrid vehicle comprising:
an engine control unit configured to generate an engine control signal representing an expected engine torque;
an engine in communication with the engine control unit and configured to generate an engine torque;
a first motor configured to generate a first motor torque;
a second motor configured to generate a second motor torque;
a gearbox selectively coupled to the engine, the first motor, and the second motor, and configured to receive at least one of the engine torque, the first motor torque, and the second motor torque;
at least one motor control unit configured to generate at least one of a first performance signal representing one or more operating characteristics of the first motor and a second performance signal representing one or more operating characteristics of the second motor;
a controller in communication with the engine control unit and one or more of the motor control units to receive the engine control signal and the first and second performance signals; and
wherein the controller is configured to determine whether the engine torque produced by the engine is substantially the same as the expected engine torque based on one or more of the operating characteristics of the first motor and the second motor.
